(19) United States
(12) Patent Application Publication
(10) Pub. No.: US 2016/0098482 A1
(43) Pub. Date: Apr. 7, 2016

(54) METHOD OF ORGANIZING USER-CUSTOMIZABLE CONTENT ADAPTATION OBJECT, USER-CUSTOMIZABLE CONTENT ADAPTATION OBJECT ORGANIZING SERVER PERFORMING THE SAME AND STORAGE MEDIUM STORING THE SAME

(71) Applicant: KOREA ELECTRONICS TECHNOLOGY INSTITUTE, Seongnam-si (KR)

(72) Inventors: Jae Won MOON, Seoul (KR); Tae Beom LIM, Yongin-si (KR); Seung Woo KUM, Yongin-si (KR); Jong Bin PARK, Hwaseong-si (KR); Jong Jin JUNG, Incheon (KR); Kyung Won KIM, Seoul (KR)

(73) Assignee: KOREA ELECTRONICS TECHNOLOGY INSTITUTE, Seongnam-si (KR)

(21) Appl. No.: 14/598,503

(22) Filed: Jan. 16, 2015

(30) Foreign Application Priority Data
Oct. 6, 2014 (KR) 10-2014-0134011

(51) Int. Cl. G06F 17/30; H04L 29/08; H04M 1/725

(52) U.S. Cl. CPC G06F 17/30705; H04M 1/72563; H04L 67/02

(57) ABSTRACT

A method of organizing a user-customizable content adaptation object being performed on a user-customizable content adaptation object organizing server, the server being coupled to a user terminal, the method includes: (a) classifying at least one resource based on a context category; (b) selecting at least one classified content adaptation object based on a context to associate the at least one classified content adaptation object with an object collector, the at least one classified content adaptation object respectively corresponding to a computer-executable object, and being capable of receiving a remote response by the user terminal or being applied to the user terminal; (c) generating a collector layout page including the at least one content adaptation object in the object collector; and (d) providing the generated collector layout page to the user terminal.

### CROSS-REFERENCE TO RELATED APPLICATIONS

This application claims priority from Korean Patent Application No. 10-2014-0134011, filed on Oct. 6, 2014, the disclosure of which is incorporated herein in its entirety by reference.

### BACKGROUND

1. Field

Methods and apparatuses consistent with exemplary embodiments of the inventive concept relate to organizing a user-customizable content adaptation object, more particularly to organizing a user-customizable content adaptation object, a user-customizable content adaptation object organizing server performing the same and a storage medium storing the same generating a collector layout page including a content adaptation object selected based on a context to provide the generated collector layout page to a user terminal.

2. Description of the Related Art

In general, a user interface (UI) corresponds to a part of a program causing a user and a program to interact to cause the user and a computer to exchange information and a framework corresponds to a predetermined frame performing an any project on a web or a program. That is, a user interface framework corresponds to a frame organizing the user interface.

The Korean Patent Publication No. 10-2014-0019626 relates to a user interface framework for developing web applications, which can provide a user experience (UX) at a native application level in a mobile environment, provide high-usability UI widgets and application programming interfaces (APIs) when producing mobile web applications, thereby being applicable to N-screens using one source, enable a user to extend built-in widgets, and support an absolute coordinate system and a relative coordinate system at the same time when developing web applications, thereby improving user convenience.

The Korean Patent Publication No. 10-2008-0022697 relates to a dynamical UI framework and a UI implementing method based on the same and a technology based on the UI framework providing a function to dynamically download and select the user interface from a terminal. This technology may provide the flexible and dynamic UI to the user, whereby the user may dynamically change the UI of a personal information device according to individual preference and convenience.

### SUMMARY

Example embodiments of the inventive concept provide a method of organizing a user-customizable content adaptation object capable of providing a content application object associated with a corresponding context based on a context obtained from a user.

Example embodiments of the inventive concept provide a method of organizing a user-customizable content adaptation object capable of representing a content adaptation object on a resource layout template based on a characteristic of the content adaptation object.

Example embodiments of the inventive concept provide a method of organizing a user-customizable content adaptation object capable of performing an adaptation to cause a content adaptation object to be rendered based on a type of a user terminal.

Example embodiments of the inventive concept provide a method of organizing a user-customizable content adaptation object capable of periodically obtaining a context from a user and regenerating a collector layout page based on a user action for a collector layout page.

According to an aspect of an example embodiment, there is provided a method of organizing a user-customizable content adaptation object being performed on a user-customizable content adaptation object organizing server, the server being coupled to a user terminal. The method may include: (a) classifying at least one content adaptation object based on a context category, (b) selecting at least one classified content adaptation object based on a context to associate the at least one classified content adaptation object with an object collector, the at least one classified content adaptation object respectively corresponding to a computer-executable object, and being capable of receiving a remote response by the user terminal or being applied to the user terminal, (c) generating a collector layout page including the at least one content adaptation object in the object collector and (d) providing the generated collector layout page to the user terminal.

The at least one content adaptation object may be included in a plurality of context categories.

The context may correspond to at least one of a type of the user terminal, a user profile associated with the user terminal, a user emotion and a user's surrounding environment.

Step (b) may include requesting context category information associated with the collector layout page from the user terminal, the collector layout page being generated.

Step (b) may further include obtaining the context from at least one of the user terminal, a sensor associated with the user terminal and a device possessed by a user.

Step (c) may include performing an adaptation based on a type of the user terminal to control the at least one content adaptation object to be rendered to the user terminal.

Step (c) may include arranging the at least one content adaptation object in an object layout template predetermined by a user based on a characteristic of the at least one content adaptation object.

The method may further include periodically receiving the context from the user terminal to select at least one another content adaptation object to be associated with the object collector.

The user terminal may determine a weight for the at least one content adaptation object included in the collector layout page based on a user action for the provided collector layout page.

The method may further include regenerating the collector layout page based on the at least one other reselected content adaptation object to provide the regenerated collector layout page to the user terminal.

According to an aspect of another example embodiment, there is provided a user-customizable content adaptation object organizing server which may include: a page manager configured to classify at least one content adaptation object based on a context category; an object collector configured to select at least one classified content adaptation object based on a context to associate the at least one classified content adaptation object to an object collector, the at least one classified content adaptation object respectively corresponding to a computer-executable object, and being capable of receiving a remote response by the user terminal or being applied to the user terminal; a page generating processor configured to generate a collector layout page including the at least one content adaptation object in the object collector; and a page provider configured to provide the generated collector layout page to the user terminal.

The page generating processor may be further configured to periodically receive the context from the user terminal to reselect at least one another content adaptation object to be associated with the object collector.

The page generating processor may be further configured to regenerate the collector layout page based on the at least one other reselected content adaptation object to provide the regenerated collector layout page to the user terminal.

According to an aspect of still another example embodiment, there is provided a machine-readable non-transitory medium which may store a computer program for a method of organizing a user-customizable content adaptation object being performed on a user-customizable content adaptation object organizing server, the server being coupled to a user terminal. The machine-readable non-transitory medium may store thereon machine-executable instructions for: classifying at least one content adaptation object based on a context category, selecting at least one classified content adaptation object based on a context to associate the at least one classified content adaptation object to an object collector, the at least one classified content adaptation object respectively corresponding to a computer-executable object, and being capable of receiving a remote response by the user terminal or being applied to the user terminal, generating a collector layout page including the at least one content adaptation object in the object collector and providing the generated collector layout page to the user terminal.

The method of organizing a user-customizable content adaptation object and related technologies according to an example embodiment may provide a content application object associated with a corresponding context based on a context obtained from a user.

The method of organizing a user-customizable content adaptation object and related technologies according to an example embodiment may arrange or dispose a content adaptation object on a resource layout template based on a characteristic of the content adaptation object.

The method of organizing a user-customizable content adaptation object and related technologies according to an example embodiment may perform an adaptation to control a content adaptation object to be rendered based on a type of a user terminal.

The method of organizing a user-customizable content adaptation object and related technologies according to an example embodiment may periodically obtain a context from a user and regenerating a collector layout page based on a user action for a collector layout page.

### BRIEF DESCRIPTION OF THE DRAWINGS

FIG. 1 is a block diagram illustrating a user-customizable content adaptation object organizing system, according to an example embodiment.

FIG. 2 is a block diagram illustrating a user-customizable content adaptation object organizing server in FIG. 1, according to an example embodiment.

FIG. 3 is an flow chart illustrating a user-customizable content adaptation object organizing system in FIG. 1, according to an example embodiment.

FIG. 4 is an example illustrating information of a content adaptation object.

FIG. 5 is an example illustrating a form corresponding a resource type being used for a resource adapter of a page generating unit of FIG. 3.

FIG. 6 is an example applying a library being used for a page generator of a page generating unit of FIG. 3.

FIGS. 7A and 7B illustrate an example illustrating a collector layout page generated according to an example embodiment of the present invention.

### DETAILED DESCRIPTION OF THE EXEMPLARY EMBODIMENTS

Explanation of the inventive concept is merely exemplary embodiments for structural or functional explanation, so the scope of the inventive concept should not be construed to be limited to the embodiments explained herein. That is, since the embodiments may be implemented in several forms without departing from the characteristics thereof, it should also be understood that the described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

Terms described in the present disclosure may be understood as follows.

While terms such as “first” and “second,” etc., may be used to describe various components, such components must not be understood as being limited to the above terms. The above terms are used to distinguish one component from another. For example, a first component may be referred to as a second component without departing from the scope of rights of the present invention, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Meanwhile, other expressions describing relationships between components such as “between”, “immediately between” or “adjacent to” and “directly adjacent to” may be construed similarly.

Singular forms “a”, “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Identification letters (e.g., a, b, c, etc.) in respective steps are used for the sake of explanation and do not describe an order of respective steps. The respective steps may be changed from a mentioned order unless specifically mentioned in context. Namely, respective steps may be performed in the same order as described, may be substantially simultaneously performed, or may be performed in reverse order.

The exemplary embodiments may be implemented as machine-readable codes on a machine-readable medium. The machine-readable medium includes any type of recording device for storing machine-readable data. Examples of the machine-readable recording medium include a read-only memory (ROM), a random access memory (RAM), a compact disk-read only memory (CD-ROM), a magnetic tape, a floppy disk, and optical data storage. The medium may also be carrier waves (e.g., Internet transmission). The computer-readable recording medium may be distributed among networked machine systems which store and execute machine-readable codes in a de-centralized manner.

The terms used in the present application are merely used to describe particular embodiments, and are not intended to limit the inventive concept. Unless otherwise defined, all terms used herein, including technical or scientific terms, have the same meanings as those generally understood by those with ordinary knowledge in the field of art to which the inventive concept belongs. Such terms as those defined in a generally used dictionary are to be interpreted to have the meanings equal to the contextual meanings in the relevant field of art, and are not to be interpreted to have ideal or excessively formal meanings unless clearly defined in the present application.

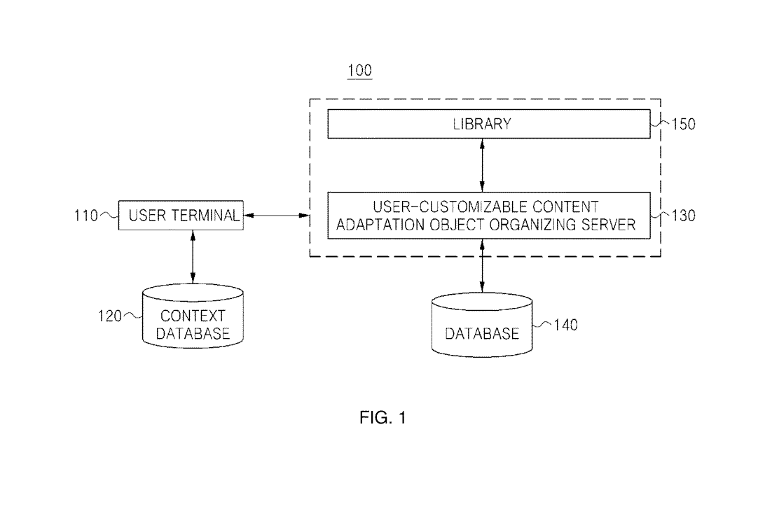

FIG. 1 is a block diagram illustrating a user-customizable content adaptation object organizing system according to an example embodiment.

Referring to FIG. 1, a user-customizable content adaptation object organizing system 100 includes a user terminal 110, a context database 120, a user-customizable content adaptation object organizing server 130, a database 140 and a library 150.

The user terminal 110 corresponds to a computing device requesting a specific page from the user-customizable content adaptation object organizing server 130 or receiving a collector layout page generated at the user-customizable content adaptation object organizing server 130 for the specific page. For example, the user terminal 110 may correspond to a mobile terminal such as a smart phone, a tablet computer, a notebook, a desktop computer or a smart TV. In one embodiment, the user terminal 110 may be connected with the context database 120 which manages context data associated with the user terminal 110 and may perform a communication with the user-customizable content adaptation object organizing server 130.

The context database 120 corresponds to a device which stores information about a context associated with the user terminal 110. In one embodiment, the context may correspond to information about a user and a situation associated with a service providing environment. The context database 120 may be connected with the user terminal 110 to receive a request for the context from the user terminal 110 and provide a corresponding context to the user terminal 110.

The user-customizable content adaptation object organizing server 130 generates the collector layout page for the specific page requested by the user terminal 110 to provide the generated collector layout page to the user terminal 110. In one embodiment, the user-customizable content adaptation object organizing server 130 may be connected with the database 140 which manages information about a content adaptation object and include a library 150 including necessary information for generating the collector layout page. Otherwise, the user-customizable content adaptation object organizing server 130 may be connected with a separately existing library 150.

The database corresponds to a device which stores and manages information about a content adaptation object being used to generate the collector layout page. In one embodiment, the database 140 includes basic information about the content adaptation object, a content substance and type information about the content adaptation object or information about a provider of the content adaptation object and may manage the content adaptation object by a smallest unit organizing the collector layout page to control the content adaptation object to be smoothly reused by the context.

The library 150 includes information being connected with the user-customizable content adaptation object organizing server 130 to organize a user interface. Herein, the library 150 may include programs being frequently used in a computer programming procedure, maintain the programs, easily perform a debugging and shorten a compile time. In one embodiment, the library 150 may include a template library, a function library, a resource library or an external link library.

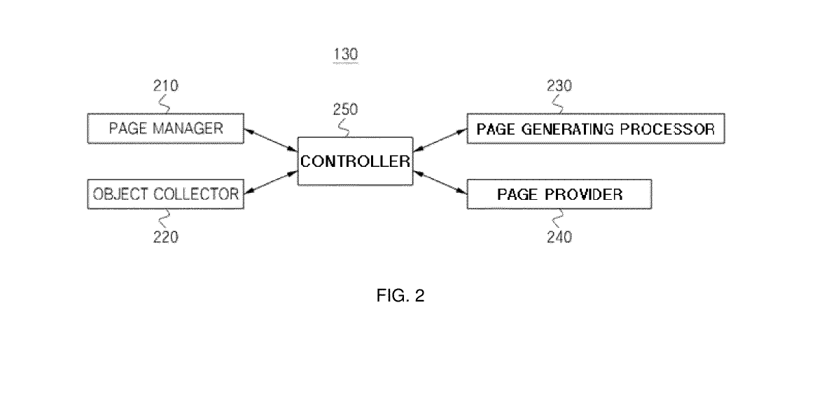

FIG. 2 is a block diagram illustrating a user-customizable content adaptation object organizing server in FIG. 1.

Referring to FIG. 2, the user-customizable content adaptation object organizing server 130 includes a page manager 210, an object collector 220, a page generating processor 230, a page provider 240 and a controller 250.

The page manager 210 classifies at least one content adaptation object based on a context category. Herein, the context category is a particular category for contexts. For example, a context corresponding to weather may include a content category corresponding to rainy, cloudy or sunny. In one embodiment, the page manager 210 may associate the at least one content adaptation object with each of a plurality of context categories by a user's determination or set to store the association relationship between the at least one content adaptation object. Also, the content adaptation object may differently set a reaction for receiving of a remote reaction according to a characteristic of content. For example, in case of movie content, when the user transmits a reaction for a corresponding content, a movie may be played. For another example, in case of design sheet content, when the user transmits a reaction to a corresponding content, a corresponding design sheet may be applied to the user terminal 110.

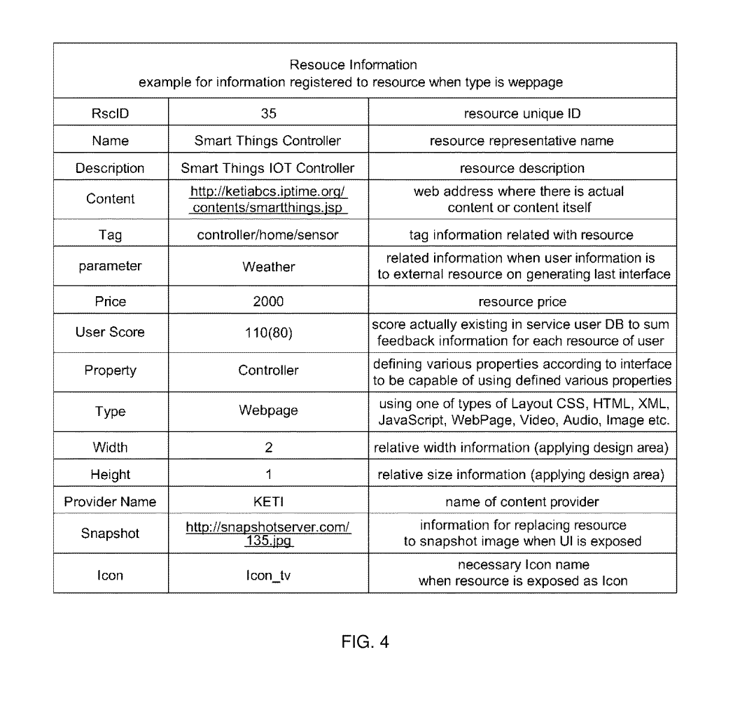

In one embodiment, the page manager 210 may use various types of content adaptation object as a unit content adaptation object, and the unit content adaptation object may have an attribute value corresponding to a basis when the collector layout page is generated. Herein, the attribute value may include a type and a property such as a name, identifier (ID), content, description, width, height, provider, load and tag value. The type may be defined by at least one of values of webpage, HTML, XML, video, audio, image, JavaScript, cascading style sheets (CSS) and layout. The property may be defined by a blog, application, control UI, news, information, content, Internet of Things (IOT) control, function, title, time, background, design, external page, internal page and layout. For example, referring to FIG. 4, the type corresponds to a property value of a unit resource corresponding to the webpage. Herein, the resource may indicate or correspond to a content adaptation object.

In one embodiment, the at least one content adaptation object may include a plurality of categories. For example, resource A, which is one content adaptation object, may be included in a context category corresponding to {weather-rainy} and a context category corresponding to {time-night}.

The object collector 220 selects at least one classified content adaptation object based on the context to associate the at least one selected content adaptation object with the object collector. Here, each of the content adaptation objects may correspond to a computer-executable object and the context may correspond to at least one of a type of the user terminal 110, a user profile associated with the user terminal 110, a user emotion and a user's surrounding environment. In more detail, the object collector 220 selects a content adaptation object associated with a corresponding context according to an association between the context category set through the page manager 210 and the content adaptation object based on a context obtained from the user terminal 110.

In one embodiment, the object collector 220 may obtain a user context from at least one of the user terminal 110, a sensor associated with the user terminal 110 and a device where the user possess associated with the user terminal 110.

The page generating processor 230 generates a collector layout page which includes at least part of the at least one content adaptation object.

In one embodiment, the page generating processor 230 may be organized as a content adaptation object adapter and a page generator (not shown). Here, the content adaptation object adapter may perform an adaptation based on the type of the user terminal 110 to control the at least part of the content adaptation object to be rendered to the user terminal 110, and the page generator may arrange or dispose the at least part of the content adaptation object on an object layout template predetermined by the user based on a characteristic of the at least part of the content adaptation object.

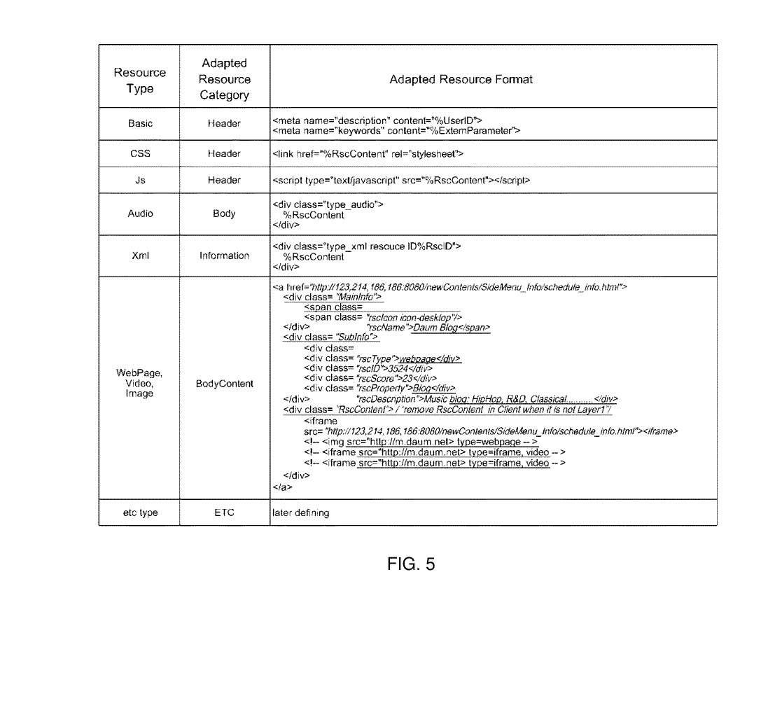

In one embodiment, the content adaptation object adapter determines a form being adapted according to a type of the content adaptation object. For example, referring to FIG. 5, a resource corresponding to a content adaptation object is classified into a header, body, information, body content, and etc. according to the type, and a form being adapted for each resource is determined. A Type of basic information, CSS and the Java Script may be classified into the header, the audio may be classified into the body, the XML may be classified into the information and a type of the webpage, video, image and HTML may be classified into the body content.

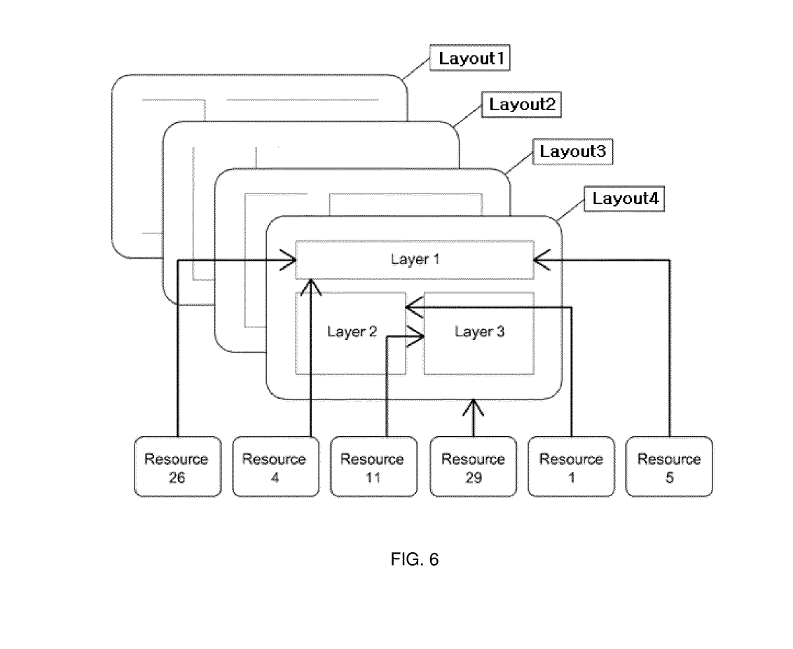

In one embodiment, the page generator hierarchically divides a collector layout page into a plurality of parts, and connects the divided parts with a library 150 suitable for each of the parts. For example, referring to FIG. 6, a collector layout page may be divided into a page part, at least one layer constituting the page and at least one content adaptation object part organizing a layer. Here, one layer may include the at least one content adaptation object (e.g., a resource) and one page may include the at least one layer. Also, each of the parts may be associated with a page library, a layer library and a content adaptation object library being independent of one another, and each of the libraries may be changed.

In one embodiment, the page generator may arrange or dispose the content adaptation object being adapted through the content adaptation object adapter on the page part and the layout part. For example, referring to FIG. 6, five (5) resources (resource 26, resource 4, resource 11, resource 29, resource 1 and resource 5) may be arranged or disposed on a template formed with three (3) layers (layer 1, layer 2 and layer 3) to generate a collector layout page.

The page provider 240 provides a collector layout page generated through the page generating processor 230 to the user terminal 110.

In one embodiment, the user-customizable content adaptation object organizing server 130 may further include a page regenerating processor (not shown). Here, the page regenerating processor may periodically receive the context from the user terminal 110 to reselect the content adaptation object being associated with the object collector. Here, the context may have a value being changeable in real time and for example, the context may correspond to a user location, temperature, weather, user emotion, time and user status. For example, when the context value corresponding to the weather and the user emotion is changed to {weather: sunny→rainy} and {user emotion: tired→sad}, the page regenerating processor may reselect a content adaptation object corresponding to {weather: rainy} and {user emotion: sad} to associate the reselected content adaptation object with the object collector. In another embodiment, the above functions of the page regenerating processor may performed by the page generating processor 230.

In one embodiment, the user terminal 110 may determine a weight for the at least one content adaptation object being included in the collector layout page based on a user action for the collector layout page provided through the page provider 240. For example, when weather information, movie image and music audio are included in the collector layout page and the user selects or has a tendency to select the weather information more than the movie image and the music audio to check the weather information more than the movie image and the music audio, the user terminal 110 may determine a weight for the weather information higher than each of weights for the movie image and the music audio to determine the weight for the content adaptation object like as {weather information: 5, movie image: 2, music audio: 2}.

In one embodiment, the page regenerating processor may regenerate the collector layout page based on the weight for the at least one content adaptation object determined from the user terminal 110. For example, when the weight is determined as {weather information: 5, movie image: 2, music audio: 2}, the page regenerating processor may allocate a larger area to the weather information in the collector layout page than the movie image and the music audio in the collector layout page or may provide detailed weather information on the collector layout page compared to the movie image and the music audio representation.

In one embodiment, the page regenerating processor may regenerate the collector layout page based on the reselected content adaptation object or the weight for the content adaptation object to the user terminal 110.

The controller 250 controls an operation or a data flow of the page manager 210, the object collector 220, the page generating processor 230 and the page provider 240.

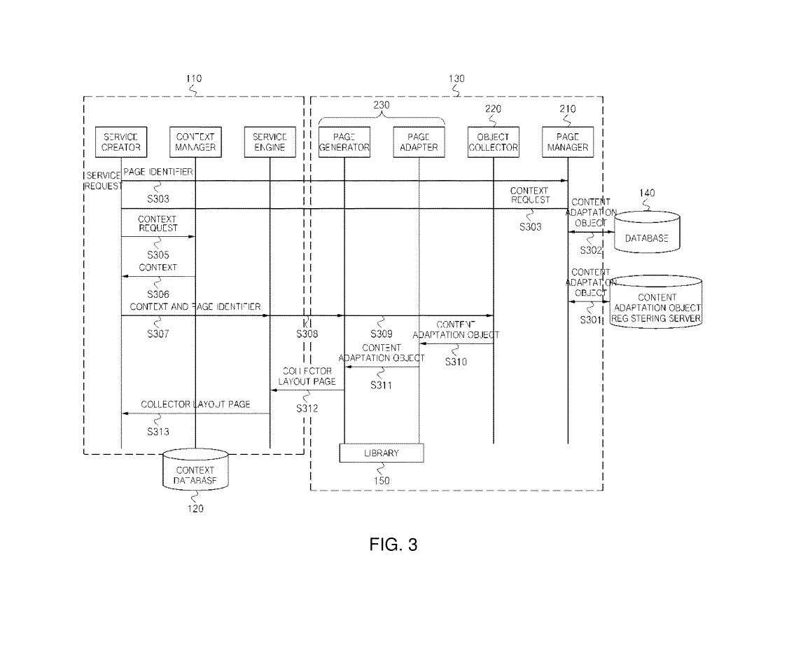

FIG. 3 is an flow chart illustrating a user-customizable content adaptation object organizing system in FIG. 1.

According to an example embodiment of FIG. 3, each of the user terminal 110 and the user-customizable content adaptation object organizing server 130 is implemented as a separate computing device and the user terminal 110 is formed of a service creator, a context manager and a service engine. The present embodiment is provided for conveniences' sake of explaining an example but should not be used to limit a scope of the inventive concept.

The page manager 210 may receive a registration of a content adaptation object from a content provider through the content adaptation object server (Step S301), and may set basic information about a collector layout page. For example, the basic information about the collector layout page may correspond to context category information for organizing a specific collector layout page based on a page identifier.

The page manager 210 may classify a content adaptation object being managed through the database 140 based on a context category (Step S302) and may store the classified information in the database 140.

A service creator of the user terminal 110 receives a request for a collector layout page for a specific page from a user to provide a page identifier for the specific page to the page manager 210 (Step S303). The page identifier may be used to identify a collector layout page being generated by the page generating processor 230 and may be implemented as a normal identifier (e.g., a page web address) or an identifier autonomously defined by the page manager 210. In FIG. 3, when the user terminal 110 wants to receive the collector layout page, the user terminal 110 may request a corresponding service from the page manager 210 through the page identifier.

The page manager 210 requests a context from the user terminal 110 based on context category information to organize a corresponding collector layout page based on the page identifier (Step S304). Here, the page identifier for the collector layout page and the context category information for organizing the collector layout page may be managed through the database 140.

The service creator of the user terminal 110 receives a context request from the page manager 210 and requests a context from the context manager to obtain a corresponding context (Step S305). In one embodiment, the service creator may request a context associated with a corresponding user identifier based on the user identifier and may not request a context being obtainable through the user identifier from the context manager. Also, the context manager may update the context database 120 based on the context obtained through the user identifier.

The context manager detects the context being requested from the service creator to provide the detected context to the service creator (Step. S306). In one embodiment, the context manager may be connected with the context database 120 to manage the context. Also, the context manager may obtain at least one of the sensor associated with the user terminal 110 and a device associated with the user terminal 110 to update the context database 120 based on the obtained context. Here, it is assumed that the user possesses the device.

The service creator provides the context, the user identifier and the page identifier being provided from the context manager to the service engine (Step S307) and the service engine provides the context, the user identifier and the page identifier to the page generator of the user-customizable content adaptation object organizing server 130 (Step S308).

The page generator provides the context and page identifier to the object collector 220 (Step S309).

The object collector 220 selects a content adaptation object associated with the context based on the context and page identifier to associate the selected content adaptation object with the object collector, and provides the at least part of the at least one content adaptation object being included in the object collector to the content adaptation object adapter (Step S310). For example, when a content adaptation object classified based on the context category corresponds to {age-10-resourceA, age-20-resourceB}, {gender-male-resourceC, gender-female-resourceD} and {weather-cloudy-reourceE, weather-sunny-reourceF} and a context being provided through the page generator corresponds to {age-10, gender-male, weather-sunny}, the resourceA, resource and reourceF may be selected to be provided to the content adaptation object adapter.

The content adaptation object adapter performs an adaptation based on the content adaptation object and the page identifier being provided from the object collector 220 to provide the content adaptation object, on which the adaptation is performed, to the page generator (Step. S311). In one embodiment, the adaption may be performed based on the type of the user terminal 110 and the content adaptation object adapter may be connected with the library 150 to receive necessary information for performing the adaptation.

The page generator generates the collector layout page based on the adapted content adaptation object and page identifier to provide the generated collector layout page the user terminal 110 (Step S312). In one embodiment, the page generator may be connected with the library 150 to receive the necessary information for generating the collector layout page.

The service engine of the user terminal 150 provides the collector layout page being provided from the user-customizable content adaptation object organizing server 130 to the service creator 313 to be providable to the user (Step S313).

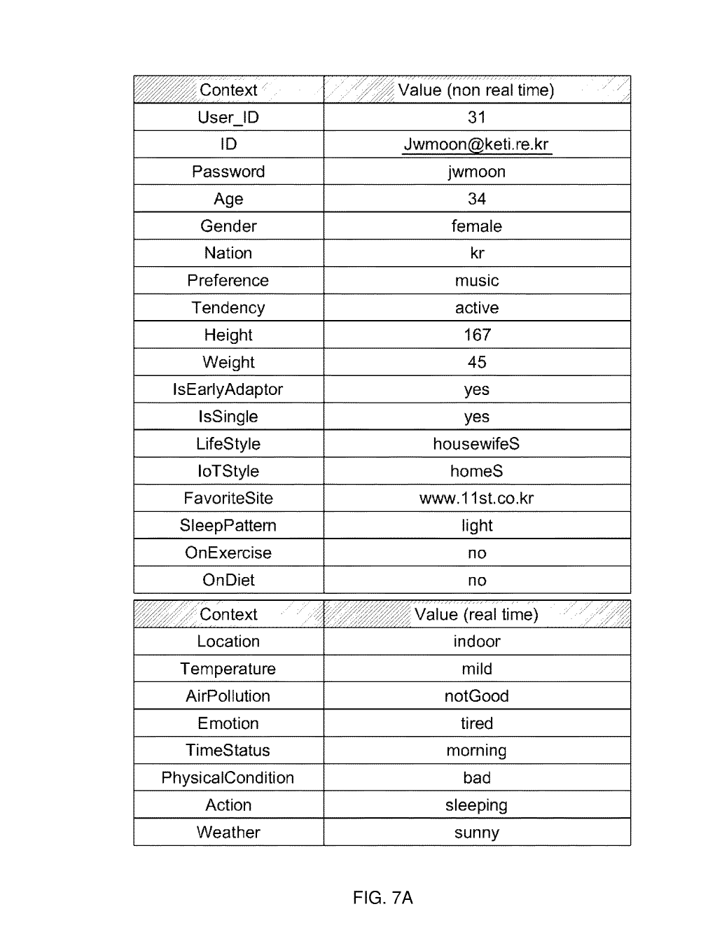

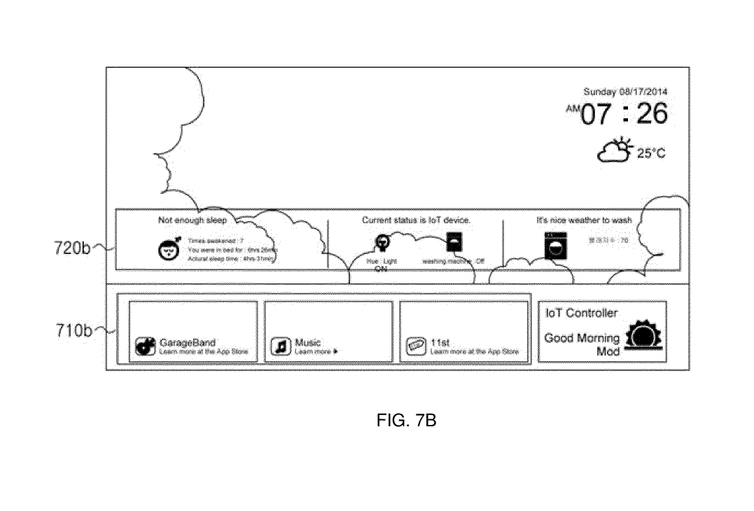

FIGS. 7A and 7B illustrate an example illustrating a collector layout page generated according to an example embodiment.

Referring to FIG. 7A, a context obtained from the user terminal 110 may include a context having a unchanged value (i.e., non-real time value) and a context having a changeable value (i.e., real time value). For example, the unchanged value may correspond to a user ID, password, age, gender or nationality and the changeable value may correspond to a location, temperature or weather.

Referring to FIG. 7B, this diagram corresponds to a collector layout page generated based on the context value of FIG. 7A. For example, when a type of the content adaptation object corresponds to an image, audio or website, the content adaptation object may be located on one part 710 according to a layout of the collector layout page, and when the type of the content adaptation object corresponds to certain information, the content adaptation object may be located on another part 720 according the layout of the collector layout page. In one embodiment, a plurality of content adaptation objects included in FIG. 7B may correspond to a content adaptation object associated with a context corresponding to {Preference-music, LifeStyle-housewifeS, loTStyle-homeS, FavoriteSitewww., 11st.co.kr, SleepPattern-light, On Exercise-no, On Diet-no, Emotion-tired, TmeStatus-morning, Weather-sunny} of contexts of FIG. 7A.

At least one of the components, elements or units represented by a block as illustrated in FIGS. 1-3 may be embodied as various numbers of hardware, software and/or firmware structures that execute respective functions described above, according to an exemplary embodiment. For example, at least one of these components, elements or units may use a direct circuit structure, such as a memory, processing, logic, a look-up table, etc. that may execute the respective functions through controls of one or more microprocessors or other control apparatuses. Also, at least one of these components, elements or units may be specifically embodied by a module, a program, or a part of code, which contains one or more executable instructions for performing specified logic functions. Also, at least one of these components, elements or units may further include a processor such as a central processing unit (CPU) that performs the respective functions, a microprocessor, or the like. Further, although a bus is not illustrated in the above block diagrams, communication between the components, elements or units may be performed through the bus. Functional aspects of the above exemplary embodiments may be implemented in algorithms that execute on one or more processors. Furthermore, the components, elements or units represented by a block or processing steps may employ any number of related art techniques for electronics configuration, signal processing and/or control, data processing and the like.

Although this document provides descriptions of example embodiments, it would be understood by those skilled in the art that the example embodiments can be modified or changed in various ways without departing from the technical principles and scope of the inventive concept defined by the appended claims.

What is claimed is:

1. A method of organizing a user-customizable content adaptation object being performed on a user-customizable content adaptation object organizing server, the server being coupled to a user terminal, the method comprising:
(a) classifying at least one content adaptation object based on a context category;
(b) selecting at least one classified content adaptation object based on a context to associate the at least one classified content adaptation object with an object collector, the at least one classified content adaptation object respectively corresponding to a computer-executable object, and being capable of receiving a remote response by the user terminal or being applied to the user terminal;
(c) generating a collector layout page including the at least one content adaptation object in the object collector; and
(d) providing the generated collector layout page to the user terminal.

2. The method of claim 1, wherein the at least one content adaptation object is included in a plurality of context categories.

3. The method of claim 1, wherein the context corresponds to at least one of a type of the user terminal, a user profile associated with the user terminal, a user emotion and a user's surrounding environment.

4. The method of claim 1, wherein step (b) comprises requesting context category information associated with the collector layout page from the user terminal.

5. The method of claim 4, wherein step (b) further comprises obtaining the context from at least one of the user terminal, a sensor associated with the user terminal and a device possessed by a user.

6. The method of claim 1, wherein step (c) comprises performing an adaptation based on a type of the user terminal to control the at least one content adaptation object to be rendered to the user terminal.

7. The method of claim 1, wherein step (c) comprises arranging the at least one content adaptation object in an object layout template predetermined by a user based on a characteristic of the at least one content adaptation object.

8. The method of claim 1, further comprising:
periodically receiving the context from the user terminal to select at least one another content adaptation object to be associated with the object collector.

9. The method of claim 8, wherein the user terminal determines a weight for the at least one content adaptation object included in the collector layout page based on a user action for the provided collector layout page.

10. The method of claim 8, further comprising:
regenerating the collector layout page based on the at least one other reselected content adaptation object to provide the regenerated collector layout page to the user terminal.

11. A user-customizable content adaptation object organizing server comprising:
a page manager configured to classify at least one content adaptation object based on a context category;
an object collector configured to select at least one classified content adaptation object based on a context to associate the at least one classified content adaptation object to an object collector, the at least one classified content adaptation object respectively corresponding to a computer-executable object, and being capable of receiving a remote response by the user terminal or being applied to the user terminal;
a page generating processor configured to generate a collector layout page including the at least one content adaptation object in the object collector; and
a page provider configured to provide the generated collector layout page to the user terminal.

12. The server of claim 11, wherein the page generating processor is further configured to periodically receive the context from the user terminal to reselect at least one another content adaptation object to be associated with the object collector.

13. The server of claim 12, wherein the page generating processor is further configured to regenerate the collector layout page based on the at least one other reselected content adaptation object to provide the regenerated collector layout page to the user terminal.

14. A machine-readable non-transitory medium storing a computer program for a method of organizing a user-customizable content adaptation object being performed on a user-customizable content adaptation object organizing server, the server being coupled to a user terminal, the machine-readable non-transitory medium having stored thereon machine-executable instructions for:
classifying at least one content adaptation object based on a context category;
selecting at least one classified content adaptation object based on a context to associate the at least one classified content adaptation object to an object collector, the at least one classified content adaptation object respectively corresponding to a computer-executable object, and being capable of receiving a remote response by the user terminal or being applied to the user terminal;
generating a collector layout page including the at least one content adaptation object in the object collector; and
providing the generated collector layout page to the user terminal.
